(19) United States
(12) Patent Application Publication
(10) Pub. No.: US 2023/0242118 A1
(43) Pub. Date: Aug. 3, 2023

(54) VEHICLE LOCAL MOTION PLANNING

(71) Applicants: Ford Global Technologies, LLC, Dearborn, MI (US); THE REGENTS OF THE UNIVERSITY OF MICHIGAN, Ann Arbor, MI (US)

(72) Inventors: Gabor Orosz, Ann Arbor, MI (US); Sanghoon Oh, Ann Arbor, MI (US); Hongtei Eric Tseng, Canton, MI (US); Qi Chen, Canton, MI (US); Gaurav Pandey, College Station, TX (US)

(73) Assignees: Ford Global Technologies, LLC, Dearborn, MI (US); THE REGENTS OF THE UNIVERSITY OF MICHIGAN, Ann Arbor, MI (US)

(21) Appl. No.: 17/589,930

(22) Filed: Feb. 1, 2022

(51) Int. Cl. B60W 30/18; B60W 10/04; B60W 10/20; B60W 60/00

(52) U.S. Cl. CPC B60W 30/18145; B60W 10/04; B60W 10/20; B60W 60/001; B60W 2710/20; B60W 2720/10; B60W 2720/12; B60W 2720/106; B60W 2720/125; B60W 2556/45; B60W 2554/00

(57) ABSTRACT

A computer includes a processor and a memory storing instructions executable by the processor to receive a waypoint; generate a path for a vehicle from a starting point to the waypoint, the path characterized by a preset number of parameters; and instruct a propulsion and a steering system of the vehicle to actuate to navigate the vehicle along the path.

### BACKGROUND

Some vehicles are equipped to operate autonomously or semi-autonomously. A computer on board a vehicle is programmed to operate the vehicle partially or fully independently of the intervention of a human operator. The computer is programmed to operate the propulsion, brake system, steering system, and/or other vehicle systems. Autonomous operation means the computer controls the propulsion, brake system, and steering system without input from a human operator; semi-autonomous operation means the computer controls one or two of the propulsion, brake system, and steering system and a human operator controls the remainder; and nonautonomous operation means a human operator controls the propulsion, brake system, and steering system.

### BRIEF DESCRIPTION OF THE DRAWINGS

FIG. 1 is a block diagram of an example vehicle.

FIG. 2 is a diagram of an example global path planned for the vehicle.

FIG. 3 is a diagrammatic top view of the vehicle.

FIG. 4 is a plot of an example local path planned for the vehicle.

FIG. 5 is a plot of curvature of the local path.

FIG. 6 is a plot of an example boundary between infeasible and feasible local paths.

FIG. 7 is a diagram of a swept volume of the vehicle.

FIG. 8A is a plot of velocity versus path length for an example velocity plan of the vehicle.

FIG. 8B is a plot of acceleration versus path length for the velocity plan.

FIG. 9 is a process flow diagram of an example process for planning the local path.

### DETAILED DESCRIPTION

The system and techniques herein provide local motion planning for an autonomous or semi-autonomous vehicle in a computationally efficient manner. The system can receive a waypoint, e.g., from a global motion-planning algorithm, generate a path for the vehicle from a starting point to the waypoint, generate a velocity plan for the vehicle to follow while traveling along the path, and actuate a propulsion and a steering system of the vehicle to navigate the vehicle along the path according to the velocity plan. The path is characterized by a preset number of parameters. For example, the path can be represented as a piecewise function, and the parameters can define the function, e.g., as path lengths of the pieces of the piecewise function, as coefficients of terms of a formula for the function, etc. Determining a path characterized a preset number of parameters can be more computationally efficient than determining a path characterized by, e.g., a densely packed sequence of intermediate waypoints between the starting point and the waypoint. Moreover, the vehicle can transmit the path more quickly to other vehicles because a message containing the parameters can be considerably smaller than a message containing intermediate waypoints. Paths generated as described herein can thus provide a basis for coordinated motion planning between multiple vehicles.

A computer includes a processor and a memory storing instructions executable by the processor to receive a waypoint; generate a path for a vehicle from a starting point to the waypoint, the path characterized by a preset number of parameters; and instruct a propulsion and a steering system of the vehicle to actuate to navigate the vehicle along the path.

The instructions may further include instructions to, after generating the path, generate a velocity plan for the vehicle to follow while traveling along the path. The path may be represented as a piecewise function, and generating the velocity plan may include determining a piecewise constant acceleration for the path. The parameters may be first parameters, the velocity plan may be characterized by a preset number of second parameters, and the second parameters may define a plurality of constant accelerations forming the piecewise constant acceleration.

Generating the velocity plan may include interpolating the piecewise constant acceleration with a constant jerk.

The parameters may be first parameters, and the velocity plan may be characterized by a preset number of second parameters.

The path may be twice continuously differentiable.

The path may include at least one clothoid function. The path may include three clothoid functions. The three clothoid functions may include a first clothoid function extending from the starting point to a first point, a second clothoid function extending from the first point to a second point, and a third clothoid function extending from a third point to the waypoint. A curvature of the first clothoid function at the first point may equal a curvature of the second clothoid function at the first point, and a curvature of the second clothoid function at the second point may equal a curvature of the third clothoid function at the second point.

The parameters may define path lengths for the clothoid functions.

The parameters may define rates of change of curvature for the clothoid functions.

The parameters may define the starting point and the waypoint.

The instructions may further include instructions to transmit a message to a remote receiver, the message including the parameters. The parameters may be first parameters; the instructions may further include instructions to, after generating the path, generate a velocity plan for the vehicle to follow while traveling along the path; the velocity plan is characterized by a preset number of second parameters; and the message includes the second parameters.

The instructions may further include instructions to determine a feasibility of generating the path, and generating the path may include generating the path upon determining that generating the path is feasible. The instructions may further include instructions to request a replacement waypoint upon determining that generating the path is infeasible.

The instructions may further include instructions to determine a swept volume of the vehicle based on the path and, upon determining that an object is in the swept volume, request a replacement waypoint.

A method includes receiving a waypoint; generating a path for a vehicle from a starting point to the waypoint, the path characterized by a preset number of parameters; and instructing a propulsion and a steering system of the vehicle to actuate to navigate the vehicle along the path.

With reference to the Figures, wherein like numerals indicate like parts throughout the several views, a computer 102 includes a processor and a memory storing instructions executable by the processor to receive a waypoint 104; generate a path 106 for a vehicle 100 from a starting point 108 to the waypoint 104, the path 106 characterized by a preset number of first parameters; and instruct a propulsion 110 and a steering system 112 of the vehicle 100 to actuate to navigate the vehicle 100 along the path 106.

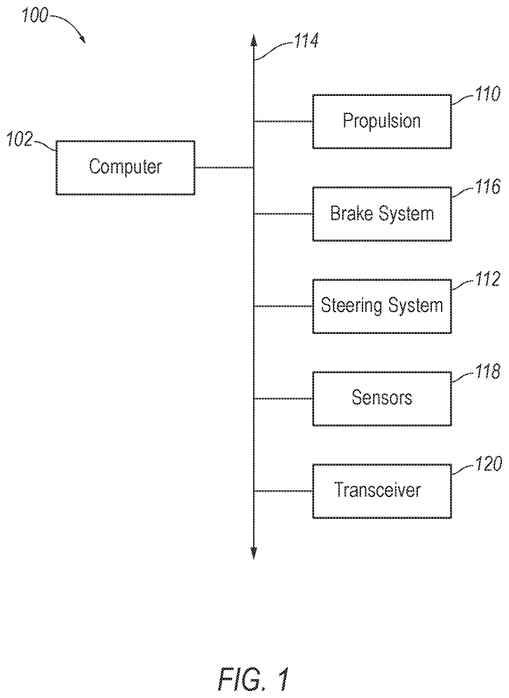

With reference to FIG. 1, the vehicle 100 may be any passenger or commercial automobile such as a car, a truck, a sport utility vehicle, a crossover, a van, a minivan, a taxi, a bus, etc.

The vehicle 100 may be an autonomous vehicle. The computer 102 can be programmed to operate the vehicle 100 independently of the intervention of a human operator, completely or to a lesser degree. The computer 102 may be programmed to operate the propulsion 110, a brake system 116, the steering system 112, and/or other vehicle systems. For the purposes of this disclosure, autonomous operation means the computer 102 controls the propulsion 110, brake system 116, and steering system 112 without input from a human operator; semi-autonomous operation means the computer 102 controls one or two of the propulsion 110, brake system 116, and steering system 112 and a human operator controls the remainder; and nonautonomous operation means a human operator controls the propulsion 110, brake system 116, and steering system 112.

The computer 102 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 102 can thus include a processor, a memory, etc. The memory of the computer 102 can include media for storing instructions executable by the processor as well as for electronically storing data and/or databases, and/or the computer 102 can include structures such as the foregoing by which programming is provided. The computer 102 can be multiple computers coupled together. The computer 102 can be located on board the vehicle 100. Alternatively, the computer 102 can be located externally to the vehicle 100, e.g., in an infrastructure component, and the computer 102 can remotely instruct the propulsion 110, the brake system 116, and the steering system 112 to actuate.

The computer 102 may transmit and receive data through a communications network 114 such as a controller area network (CAN) bus, Ethernet, WiFi, Local Interconnect Network (LIN), onboard diagnostics connector (OBD-II), and/or by any other wired or wireless communications network. The computer 102 may be communicatively coupled to the propulsion 110, the brake system 116, the steering system 112, sensors 118, a transceiver 120, and other components via the communications network 114.

The propulsion 110 of the vehicle 100 generates energy and translates the energy into motion of the vehicle 100. The propulsion 110 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion 110 can include an electronic control unit (ECU) or the like that is in communication with and receives input from the computer 102 and/or a human operator. The human operator may control the propulsion 110 via, e.g., an accelerator pedal and/or a gear-shift lever.

The brake system 116 is typically a conventional vehicle braking subsystem and resists the motion of the vehicle 100 to thereby slow and/or stop the vehicle 100. The brake system 116 may include friction brakes such as disc brakes, drum brakes, band brakes, etc.; regenerative brakes; any other suitable type of brakes; or a combination. The brake system 116 can include an electronic control unit (ECU) or the like that is in communication with and receives input from the computer 102 and/or a human operator. The human operator may control the brake system 116 via, e.g., a brake pedal.

The steering system 112 is typically a conventional vehicle steering subsystem and controls the turning of the wheels. The steering system 112 may be a rack-and-pinion system with electric power-assisted steering, a steer-by-wire system, as both are known, or any other suitable system. The steering system 112 can include an electronic control unit (ECU) or the like that is in communication with and receives input from the computer 102 and/or a human operator. The human operator may control the steering system 112 via, e.g., a steering wheel.

The sensors 118 may provide data about operation of the vehicle 100, for example, wheel speed, wheel orientation, and engine and transmission data (e.g., temperature, fuel consumption, etc.). The sensors 118 may detect the location and/or orientation of the vehicle 100. For example, the sensors 118 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 118 may detect the external world, e.g., objects and/or characteristics of surroundings of the vehicle 100, such as other vehicles, road lane markings, traffic lights and/or signs, pedestrians, etc. For example, the sensors 118 may include radar sensors, scanning laser range finders, light detection and ranging (LIDAR) devices, and image processing sensors such as cameras.

The transceiver 120 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 120 may be adapted to communicate with a remote receiver, that is, a computer distinct and spaced from the vehicle 100. The remote receiver may be located outside the vehicle 100. For example, the remote receiver may be associated with another vehicle (e.g., V2V communications), an infrastructure component (e.g., V21 communications), an emergency responder, a mobile device associated with the owner of the vehicle 100, etc. The transceiver 120 may be one device or may include a separate transmitter and receiver.

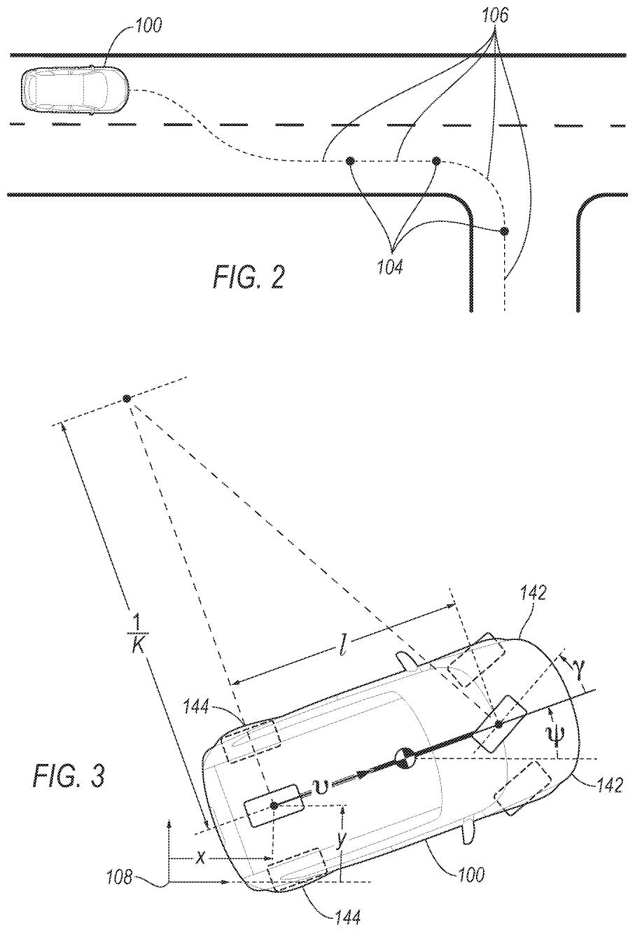

With reference to FIG. 2, the computer 102 can be programmed to provide global motion planning and thereby generate waypoints 104. For the purposes of this disclosure, a “waypoint” is a physical position through which the vehicle 100 has been planned to pass. The waypoints 104 can be spaced apart, e.g., on different sides of an intersection, as shown in FIG. 2. The computer 102 can use any suitable algorithm for global motion planning, e.g., an incremental-search based planner such as rapidly exploring random tree (RRT), graph-based planning methods that use road structures, sampline-based methods such as probabilistic roadmap path (PRM) planning, etc. The computer 102 can generate the waypoints 104 either one at a time or in sets.

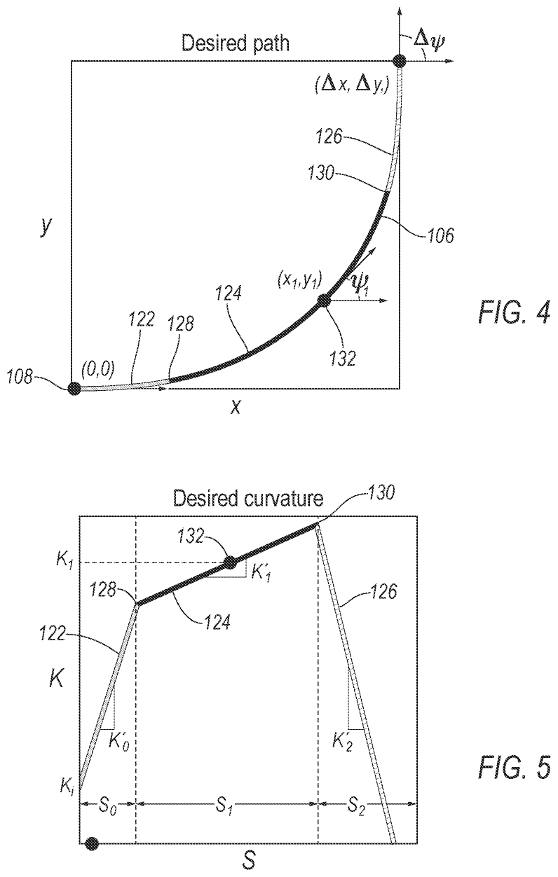

The computer 102 is programmed to receive the waypoint 104, e.g., from the algorithm for global motion planning. The waypoint 104 can be defined in terms of a global coordinate system or a local coordinate system centered on the starting point 108 of the vehicle 100, e.g., (Ax, Ay), as illustrated in FIG. 4. For the purposes of this disclosure, the “starting point” is the position of the vehicle 100 at the start of the path 106 to be generated to the waypoint 104.

With reference to FIG. 3, the motion of the vehicle 100 can be described using any suitable kinematic model, e.g., a single-track or bicycle model. The coordinate system can have its origin at the starting point 108. FIG. 3 shows the vehicle 100 after traveling away from the starting point 108, e.g., partway along the path 106. A state of the vehicle 100 can include a position (x, y), a yaw angle ψ, and a longitudinal velocity ν, e.g., X=[x, y, ψ, ν]^{T}. The position (x, y) of the vehicle 100 can be the coordinates of a center of a rear axle of the vehicle 100. The yaw angle ψ is a rotation of the vehicle 100 around a vertical axis from an orientation pointing straight along the x-axis. The longitudinal velocity ν is a speed of the vehicle 100 in the direction that the vehicle 100 is facing. Inputs to the model, i.e., control variables, can include a steering angle γ and a longitudinal acceleration a, e.g., u=[γ, a]^{T}. The motion can be modeled by, e.g., the following equations:

$$\dot{x} = v cos ψ$$

$$\dot{y} = v sin ψ$$

$$\dot{ψ} = \frac{v}{l} tan γ$$

$$\dot{v} = a$$

in which the dot operator indicates a time derivative and l is the wheelbase.

Constraints on the inputs u can include a maximum steering angle γ, a maximum rate of change of the steering angle γ, and a minimum and maximum acceleration a, all based on the physical constraints of the vehicle 100, and a maximum jerk \dot{a} based on occupant comfort. For example, those four constraints can be modeled by the following respective equations:

|γ|≤γₘₐₓ

|\dot{γ}|≤Ωₘₐₓ

aₘᵢₙ≤a≤aₘₐₓ

|\dot{a}|=jₘₐₓ

According to the model, the curvature κ of a turn that the vehicle 100 is performing can be dictated by the steering angle γ., e.g., according to the following equation of the model:

$$κ = \frac{tan γ}{l}$$

Setting the steering angle γ can be equivalent to setting the curvature κ of the path 106.

With reference to FIG. 4, the model can include boundary conditions, e.g., with the starting point 108 at the origin of the coordinate system; a starting yaw angle of zero; a final position, i.e., the waypoint 104, at (Δx, Δy) after a time T, and a final yaw angle of Δψ. The boundary conditions can be described by the following equations:

x(0)=0,y(0)=0,ψ(0)=0,ν(0)=νᵢ,γ(0)=γᵢ

x(T)=Δx,y(T)=Δy,ψ(T)=Δψ,ν(T)=ν_{f},γ(T)=0

in which T is the time to travel from the starting point 108 to the waypoint 104, νᵢ is the initial longitudinal velocity, γᵢ is the initial steering angle, and ν_{f} is the final velocity. The travel time Tis not set before generating the path 106. The initial longitudinal velocity νᵢ, the initial steering angle γᵢ, and the final velocity ν_{f} may or may not be set before generating the path 106. As will be described below, these values can be determined by generating the path 106.

The model can be parameterized by switching the independent variable from time t to distance s traveled by the vehicle 100 from the starting point 108, i.e., arclength parameterization. Parameterization facilitates generating the path 106 and generating the velocity plan as separate steps. The model parameterized with the arclength s can be represented by the following equations:

x′(s)=cos ψ(s)

y′(s)=sin ψ(s)

ψ′(s)=κ(s)

in which the prime symbol indicates a derivative with respect to s. The boundary conditions can be parameterized with the following equations:

$$x ( 0 ) = 0 , y ( 0 ) = 0 , ψ ( 0 ) = 0 , κ ( ) = \frac{tan {γ}_{i}}{l} = {κ}_{i}$$

$$x ( {s}_{f} ) = Δ x , y ( {s}_{f} ) = Δ y , ψ ( {s}_{f} ) = Δ ψ , κ ( {s}_{f} ) = 0$$

The constraint for maximum steering angle γ can be parameterized with the following equation:

$$\vert κ ( s ) \vert \leq \frac{tan {γ}_{max}}{l}$$

With reference to FIG. 4, the computer 102 is programmed to generate the path 106 for the vehicle 100 from the starting point 108 to the waypoint 104. The path 106 can be represented as a piecewise function, i.e., a plurality of segments 122, 124, 126 connected together with each segment defined by a function. The functions for each segment 122, 124, 126 can be representable with a mathematical formula, meaning that the functions are not merely an ordered listing of coordinates. The path 106 can have a small number of segments 122, 124, 126, e.g., three segments 122, 124, 126. The three segments 122, 124, 126 can include a first segment 122 extending from the starting point 108 to a first point 128, a second segment 124 extending from the first point 128 to a second point 130, and a third segment 126 extending from the second point 130 to the waypoint 104. Three segments 122, 124, 126 can be the smallest number able to ensure that a path 106 exists (if feasible, as described below).

The path 106 can be twice continuously differentiable, i.e., is continuous and has continuous first and second derivatives, e.g., with respect to arclength s along the path 106, i.e., is G² smooth. Being twice continuously differentiable can prevent uncomfortable jerks or direction changes for the occupants of the vehicle 100. The path 106 can be twice continuously differentiable from the starting point 108 to the waypoint 104, including at the first point 128 and the second point 130 connecting the segments 122, 124, 126.

With reference to FIGS. 4 and 5, the path 106 can include at least one clothoid function, e.g., three clothoid functions, one for each of the segments 122, 124, 126. A clothoid function is a function whose curvature κ changes linearly with its arclength s. FIG. 4 shows the path 106 through space defined by three clothoid functions for the three respective segments 122, 124, 126, and FIG. 5 shows the curvature κ with respect to the arclength s for the same three clothoid functions. The piecewise function can be a first clothoid function for the first segment 122, a second clothoid function for the second segment 124, and a third clothoid segment for the third segment 126. As can be seen in FIG. 5, the slope for the curvature κ of each segment 122, 124, 126 is a constant value, e.g., κ′₀, κ′₁, and κ′₂, respectively, in other words, a linear change of curvature κ with respect to arclength s. The curvature of the first clothoid function at the first point 128 can equal the curvature of the second clothoid function at the first point 128, and the curvature of the second clothoid function at the second point 130 can equal the curvature of the third clothoid function at the second point 130, as indicated in FIG. 5 by the three line segments intersecting. The curvatures matching at the first point 128 and second point 130 can ensure that the piecewise function is twice continuously differentiable from the starting point 108 to the waypoint 104.

The computer 102 can be programmed to solve a system of equations defined by the boundary conditions and by the continuity of the piecewise function at the first point 128 and the second point 130. The system of equations can be written using Fresnel integrals, which are defined by the following equations:

$$A ( a , b , c ) = {\int }_{0}^{1} cos ( \frac{a}{2} {t}^{2} + b t + c ) dt$$

$$B ( a , b , c ) = {\int }_{0}^{1} sin ( \frac{a}{2} {t}^{2} + b t + c ) d t$$

Here is an example system of equations:

$${x}_{1} - \frac{{s}_{1}}{2} A ( \frac{{κ}_{1}^{′} {s}_{1}^{2}}{4} , - \frac{{κ}_{1} {s}_{1}}{2} , {ψ}_{1} ) = {s}_{0} A ( {κ}_{0}^{′} {s}_{0}^{2} , {κ}_{i} {s}_{0} , 0 )$$

$${x}_{1} + \frac{{s}_{1}}{2} A ( \frac{{κ}_{1}^{′} {s}_{1}^{2}}{4} , \frac{{κ}_{1} {s}_{1}}{2} , {ψ}_{1} ) = Δ x - {s}_{2} A ( {κ}_{2}^{′} {s}_{2}^{2} , 0 , Δ ψ )$$

$${y}_{1} - \frac{{s}_{1}}{2} B ( \frac{{κ}_{1}^{′} {s}_{1}^{2}}{4} , - \frac{{κ}_{1} {s}_{1}}{2} , {ψ}_{1} ) = {s}_{0} B ( {κ}_{0}^{′} {s}_{0}^{2} , {κ}_{i} {s}_{0} , 0 )$$

$${y}_{1} + \frac{{s}_{1}}{2} B ( \frac{{κ}_{1}^{′} {s}_{1}^{2}}{4} , \frac{{κ}_{1} {s}_{1}}{2} , {ψ}_{1} ) = Δ y - {s}_{2} B ( {κ}_{2}^{′} {s}_{2}^{2} , 0 , Δψ )$$

$$\frac{{κ}_{1}^{′} {s}_{1}^{2}}{8} - \frac{{κ}_{1} {s}_{1}}{2} + {ψ}_{1} = \frac{{κ}_{0}^{′} {s}_{0}^{2}}{2} + {κ}_{1} {s}_{0}$$

$$\frac{{κ}_{1}^{′} {s}_{1}^{2}}{8} - \frac{{κ}_{1} {s}_{1}}{2} + {ψ}_{1} = \frac{{κ}_{0}^{′} {s}_{2}^{2}}{2} + Δ ψ$$

$$- \frac{{κ}_{1}^{′} {s}_{1}}{2} + {κ}_{1} = {κ}_{i} + {κ}_{0}^{′} {s}_{0}$$

$$\frac{{κ}_{1}^{′} {s}_{1}}{2} + {κ}_{1} = - {κ}_{2}^{′} {s}_{2}$$

in which s₀, s₁, and s₂ are the lengths of the respective segments 122, 124, 126; x₁, y₁, and ψ₁ indicate position and orientation of a midpoint 132 of the second segment 124; κᵢ is the initial curvature, i.e., the curvature of the first segment 122 at the starting point 108; and κ₁=κ(s₀+s₁/2) is the curvature at the midpoint 132 of the second segment 124.

Solving the system of equations can include setting values for at least one of the unknowns. The system of equations above has eight equations and ten unknowns (s₀, s₁, s₂, x₁, y₁, ψ₁, κ₁, κ′₀, κ′₁, κ′₂), so the computer 102 can set values for two of the unknowns, e.g., the length s₀ of the first segment 122 and the length s₂ of the third segment 126, making the number of remaining unknowns equal the number of equations. For example, the lengths s₀, s₂ can be chosen to equal each other and be based on a straight-line distance from the current point to the waypoint 104. Solving the system of equations can include, after setting the values for at least one unknown, e.g., two unknowns, reducing the number of equations and/or using Newton's method. Additionally or alternatively, the computer 102 can be programmed to set a plurality of values for each of the unknowns for which values are being set, e.g., the lengths s₀, s₂, and then generate a plurality of paths 106 corresponding to the different values for those unknowns.

The result of solving the system of equations, i.e., the path 106, can be an expression for the curvature as a function of the arclength, i.e., κ(s), which can be constructed from the values of the unknowns determined by solving the system of equations. The computer 102 can be programmed to instruct the steering system 112 to set a steering angle γ based on the path 106, e.g., using the equation for curvature from above solved for the steering angle, i.e., γ=arctan(lκ(s)). Because the path 106 is expressed as a function of arclength s and not time t, the path 106 does not require any particular expression of velocity, meaning that the velocity plan can be determined as a separate step as described below.

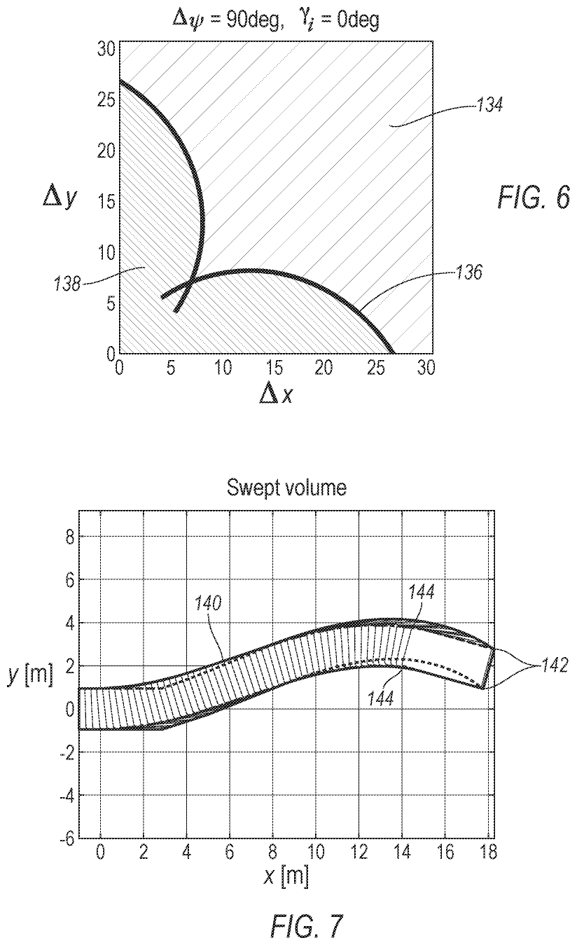

With reference to FIG. 6, the computer 102 can be programmed to determine a feasibility of generating the path 106. For the purposes of this disclosure, “feasibility” is defined as whether it is possible to generate a path 106 from the starting point 108 to the waypoint 104 without violating the constraints or boundary conditions. Generating the path 106 is feasible if it is possible given the constraints and boundary conditions, and generating the path 106 is infeasible if it is not possible given the constraints and boundary conditions. The vehicle 100 may not be able to reach all waypoints 104 with paths 106 generated as described above because of the constraint on the steering angle γ. The computer 102 can determine that generating the path 106 is feasible if a solution exists for the system of equations, and the computer 102 can determine that generating the path 106 is infeasible if no solution exists for the system of equations. The computer 102 can be programmed to, upon determining that generating the waypoint 104 is infeasible, request a replacement waypoint 104, e.g., from the algorithm for global motion planning.

For example, the computer 102 can be programmed to determine the feasibility of generating the path 106 by determining whether the waypoint 104, the initial steering angle γᵢ (or, equivalently, the initial curvature κᵢ), and/or the set value(s) for the unknowns s₀ and s₂ are within a preset zone 134. The preset zone 134 can be defined by a boundary 136 in the space of those variables, e.g., Δx, Δy, Δψ, κᵢ, s₀, and s₂. With so and s₂ set equal as described above, the preset zone 134 is in a five-dimensional space. A boundary 136 can divide the five-dimensional space into the preset zone 134 and an infeasible zone 138. FIG. 6 shows the boundary 136 between the preset zone 134 and the infeasible zone 138 with the dimensions other than position of the waypoint 104 set, reducing the preset zone 134 and the infeasible zone 138 to two dimensions for illustration. The boundary 136 can be stored in the memory of the computer 102. The boundary 136 for the preset zone 134 can be determined by solving the system of equations above without setting values for the unknowns and with an additional constraint of the maximum curvature dictated by the constraint on the steering angle γ. The system of equations and additional constraint can be solved, e.g., by using the bisection method, resulting in a three-dimensional boundary 136 in four-dimensional space. Once determined, the boundary 136 for the preset zone 134 can be stored on the computer 102, making the determination of the feasibility on board the vehicle 100 quick.

With reference to FIG. 7, the computer 102 can be programmed to determine a swept volume 140 of the vehicle 100 based on the path 106, e.g., based on the piecewise function of the path 106. For the purposes of this disclosure, a “swept volume” is defined as the union of the space occupied by the vehicle 100 while traveling along the path 106 from the starting point 108 to the waypoint 104. The computer 102 can determine the swept volume 140 by simulating movement of one or more points on the vehicle 100 through space as the vehicle 100 follows the path 106, e.g., the points having the maximum and minimum radii of curvature given the curvature of the path 106, e.g., the corners 142 of the front bumper of the vehicle 100 and the lateral ends 144 of the rear axle. The front-bumper corners 142 and the rear-axle ends 144 can be used as the points on the vehicle 100 because one of those points will have the maximum radius of curvature and one of those points will have the minimum radius of curvature for any point on the path 106, with one of those points thereby being on an outside of the swept volume 140. The swept volume 140 using the front-bumper corners 142 and the rear-axle ends 144 can be described with the following equations:

$${X}_{ra} ( s ) = {X}_{0} + sA ( {κ}^{′} {s}^{2} , κ s , {ψ}_{0} ) - \frac{w}{2} sin ψ ( s )$$

$${Y}_{ra} ( s ) = {Y}_{0} + s B ( {κ}^{′} {s}^{2} , κ s , {ψ}_{0} ) - \frac{w}{2} cos ψ ( s )$$

$${X}_{fb} ( s ) = {X}_{0} + s A ( {κ}^{′} {s}^{2} , κ s , {ψ}_{0} ) - \frac{w}{2} sin ψ ( s ) + {d}_{1} cos ψ ( s )$$

$${Y}_{fb} ( s ) = {Y}_{0} + sB ( {κ}^{′} {s}^{2} , κ s , {ψ}_{0} ) - \frac{w}{2} cos ψ ( s ) + {d}_{1} sin ψ ( s )$$

in which the subscript ra indicates the rear-axle points, the subscript fb indicates the front-bumper points, and d₁ indicates a longitudinal distance from the rear axle to the front bumper of the vehicle 100.

The computer 102 can be programmed to determine whether an object is in the swept volume 140. For example, the computer 102 can determine whether an intersection exists between a boundary of an object in the environment, as detected by the sensors 118, and the curves describing the swept volume 140 described above, e.g., using the bisection method. The object can be a stationary object. For another example, the computer 102 can determine whether an intersection exists between a second swept volume, e.g., of another vehicle, and the swept volume 140 described above. The computer 102 can receive a message, e.g., via the transceiver 120, transmitted from another vehicle that includes first parameters characterizing a path of the other vehicle, as will be described below for the vehicle 100. The computer 102 can determine the second swept volume for the other vehicle in the same manner as determining the swept volume 140 of the vehicle 100. The computer 102 can then determine whether an intersection exists between the swept volume 140 and the second swept volume.

The computer 102 can be programmed to, upon determining that an object is in the swept volume 140, request a replacement waypoint 104, e.g., from the algorithm for global motion planning. Alternatively or additionally, if the computer 102 determined a plurality of paths 106, the computer 102 can be programmed to, upon determining that an object is in the swept volume 140, determine a new swept volume for another one of the plurality of paths 106 and determine whether an object is in the new swept volume. The computer 102 can be programmed to, upon determining that one or more objects is in the swept volumes 140 for all of the plurality of paths 106, request a replacement waypoint 104.

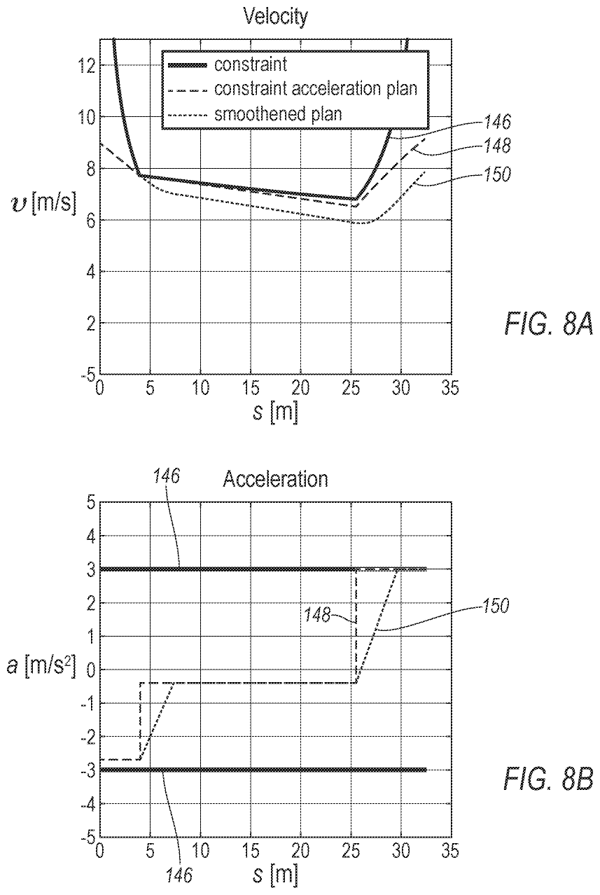

With reference to FIGS. 8A-B, the computer 102 can be programmed to, after generating the path 106, generate a velocity plan for the vehicle 100 to follow while traveling along the path 106. The velocity plan can specify the longitudinal velocity ν for each point along the path 106, e.g., ν(s), as shown in FIG. 8A, or ν(t). The velocity plan can be expressed equivalently as acceleration a for each point along the path 106, e.g., a(s), as shown in FIG. 8B, or a(t). Generating the velocity plan can include determining a piecewise constant acceleration for the path 106 and interpolating the piecewise constant acceleration with a constant jerk, as will each be described further below.

The velocity plan can be subject to constraints and/or boundary conditions. Constraints can include a minimum and maximum acceleration a based on the physical constraints of the vehicle 100, and a maximum jerk \dot{a} and a maximum longitudinal velocity ν both based on occupant comfort. The constraints can be described with the following equations:

aₘᵢₙ≤a≤aₘₐₓ

|\dot{a}|=jₘₐₓ

0≤ν(s)≤ν̅(s)

The maximum longitudinal velocity can vary with the arclength s and can be chosen to ensure a maximum lateral acceleration, e.g.,

|κ(s)|ν(s)²≤a_{lat,max}

Applying a maximum lateral acceleration according to that equation can be described with the following equation for the maximum longitudinal velocity ν as a function of arclength s:

$$\overline{v} ( s ) = min \{ \sqrt{\vert κ ( s ) \vert {a}_{lat , max}} , {Ω}_{max} \frac{1 + {l}^{2} {κ}^{2} ( s )}{l \vert {κ}^{′} ( s ) \vert} \}$$

The solid lines 146 in FIGS. 8A-B show the constraints.

The boundary conditions can include the starting and final arclength s and longitudinal velocity ν, e.g., with the following equations:

s(0)=0,ν(0)=νᵢ,s(T)=s_{f},ν(T)=ν_{f}

in which T is the time to travel from the starting point 108 to the waypoint 104, νᵢ is the initial longitudinal velocity, s_{f} is the value of arclength at the waypoint 104, and ν_{f} is the final longitudinal velocity. The travel time T is not set before generating the path 106. The initial longitudinal velocity νᵢ and the final velocity ν_{f} may or may not be set before generating the path 106. The final arclength s_{f} is known according to the generation of the path 106.

Generating the velocity plan can include determining the piecewise constant acceleration for the path 106. For example, the computer 102 can generate a value of constant acceleration for each segment of the path 106, e.g., according to the following equation:

$$a ( s ) = \{ \begin{matrix}{a}_{0} & 0 \leq s < {s}_{1} \\ {a}_{1} & {s}_{1} \leq s < {s}_{1} + {s}_{2} \\ {a}_{2} & {s}_{1} + {s}_{2} \leq s < {s}_{1} + {s}_{2} + {s}_{3}\end{matrix}$$

The constant values for the acceleration for the segments 122, 124, 126 can be given according to the following expression:

$${a}_{i} = {min}_{0 \leq s \leq {s}_{i}} \frac{1}{2 s} ( \frac{{a}_{lat , max}}{\vert {κ}_{i} + {κ}_{i}^{′} s \vert} - {v}_{i}^{2} )$$

in which i is an index of the segments 122, 124, 126 from 0 to 2. The long-dashed lines 148 in FIGS. 8A-B shows the velocity plan with piecewise constant acceleration before interpolating the piecewise constant acceleration with the constant jerk.

Generating the velocity plan can include interpolating the piecewise constant acceleration with the constant jerk. The interpolation can prevent the velocity plan from exceeding the constant jerk. Interpolating the piecewise constant acceleration with the constant jerk can include, for each pair of consecutive segments 122, 124, 126, determining a time to switch from the constant acceleration of the earlier segment to the constant acceleration of the later segment at a constant jerk, and determining a distance that the vehicle 100 will travel in the time to switch. For example, the computer 102 can determine to time to switch with the following equation:

$${T}_{i} = \frac{\vert {a}_{i} - {a}_{i - 1} \vert}{{j}_{c}}$$

in which i is an index of the later segment of the pairs of consecutive segments 122, 124, 126 from 1 to 2, and j_{c} is the constant jerk. If the constant acceleration of the earlier segment is greater than the constant acceleration of the later segment, the computer 102 can determine the travel distance for the switch with the following equation:

$${S}_{i} = ( \sqrt{{v}_{i - 1}^{2} + 2 {a}_{i - 1} {s}_{i - 1}} - {a}_{i - 1} {T}_{i} - \frac{1}{2} {j}_{c} {T}_{i}^{2} ) {T}_{i} + \frac{1}{2} {a}_{i - 1} {T}_{i}^{2} - \frac{1}{6} {j}_{c} {T}_{i}^{3}$$

Otherwise, i.e., if the constant acceleration of the earlier segment is less than the constant acceleration of the later segment, the computer 102 can determine the travel distance for the switch with the following equation:

$${S}_{i} = ( \sqrt{{v}_{i - 1}^{2} + 2 {a}_{i - 1} {s}_{i - 1}} ) {T}_{i} + \frac{1}{2} {a}_{i - 1} {T}_{i}^{2} - \frac{1}{6} {j}_{c} {T}_{i}^{3}$$

The times and distances can be applied to the acceleration plot as shown in FIG. 8B. The short-dashed lines 150 in FIGS. 8A-B shows the velocity plan after interpolating the piecewise constant acceleration with the constant jerk.

The path 106 can be characterized by a preset number of first parameters. The first parameters can define, e.g., fully define, the piecewise function defining the path 106. For example, the first parameters can define the initial steering angle γᵢ; the path lengths for the clothoid functions s₀, s₁, s₂; the rates of changes of the curvature for the clothoid functions, κ′₀, κ′₁, κ′₂; the state of the vehicle 100 at the midpoint 132 of the second segment 124, e.g., x₁, y₁, ψ₁, κ₁; the starting point 108, e.g., in global coordinates; the waypoint 104, Δx, Δy; and the change in yaw angle Δψ. The first parameters can be scalar numbers.

The velocity plan can be characterized by a preset number of second parameters. The second parameters can define, e.g., fully define, the piecewise function defining the velocity plan. For example, the second parameters can define the constant accelerations forming the piecewise constant acceleration, a₀, a₁, a₂; and the constant jerk, j_{c}. The second parameters can be scalar numbers.

The computer 102 can be programmed to transmit a message to a remote receiver, e.g., another vehicle. The message can include the first parameters and/or the second parameters. Because the first and second parameters include a preset number of scalar numbers, the message can be consistently compact while still fully defining the path 106 and velocity plan that the vehicle 100 will follow, permitting coordination with other vehicles.

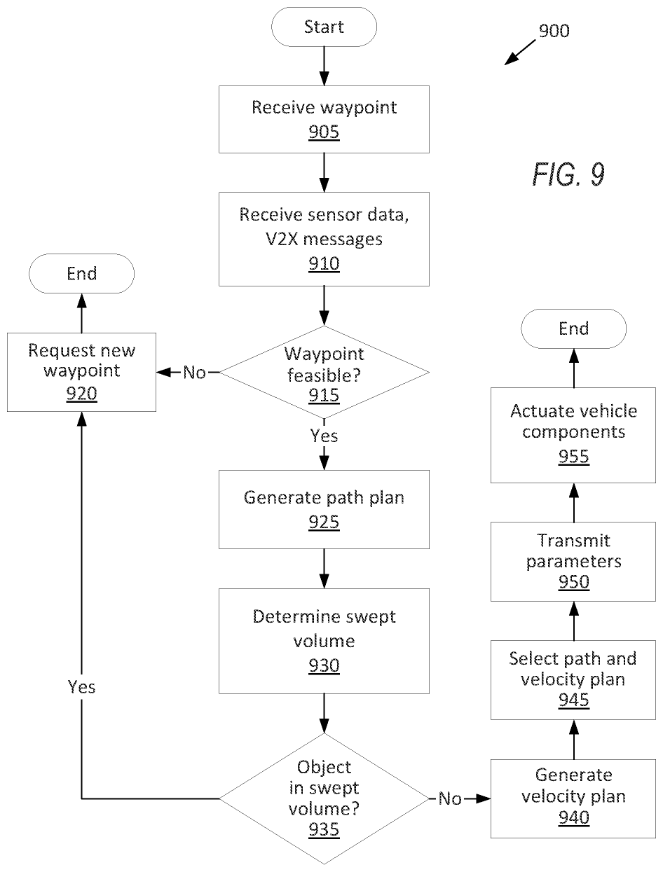

FIG. 9 is a process flow diagram illustrating an exemplary process 900 for planning the local path 106. The memory of the computer 102 stores executable instructions for performing the steps of the process 900 and/or programming can be implemented in structures such as mentioned above. The computer 102 can execute the process 900 for each traversal from the starting point 108 to the waypoint 104. The computer 102 can then execute the process 900 again with the previous waypoint 104 serving as a current starting point 108, and so on along the waypoints 104 generated by the global-motion-planning algorithm.

As a general overview of the process 900, the computer 102 receives the waypoint 104, data from the sensors 118 indicating objects in the environment, and any messages from other vehicles. If the computer 102 determines that the waypoint 104 is infeasible, the computer 102 requests a new waypoint 104. If the computer 102 determines that the waypoint 104 is feasible, the computer 102 generates the path 106 and determines the swept volume 140. If an object is in the swept volume 140, the computer 102 requests a new waypoint 104. If not, the computer 102 generates the velocity plan, transmits a message including the parameters characterizing the path 106 and the velocity plan, and instructs the propulsion 110, the steering system 112, and the brake system 116 to actuate to follow the path 106 and the velocity plan.

The process 900 begins in a block 905, in which the computer 102 receives the waypoint 104, as described above.

Next, in a block 910, the computer 102 receives data from the sensors 118 about objects in the environment. The computer 102 also receives messages from other vehicles, if any. The messages can include the first and second parameters characterizing a path and a velocity plan that will be followed by the other vehicle transmitting the message, as described above.

Next, in a decision block 915, the computer 102 determines the feasibility of generating the path 106, as described above. Upon determining that generating the path 106 is infeasible, the process 900 proceeds to a block 920. Upon determining that generating the path 106 is feasible, the process 900 proceeds to a block 925.

In the block 920, the computer 102 requests a replacement waypoint 104, as described above. After the block 920, the process 900 ends.

In the block 925, the computer 102 generates the path 106 for the vehicle 100 from the starting point 108 to the waypoint 104, as described above. The computer 102 may generate a plurality of paths 106, as described above.

Next, in a block 930, the computer 102 determines the swept volume 140 of the path 106 or paths 106, as described above.

Next, in a decision block 935, the computer 102 determines whether an object is in the swept volume 140, as described above. If the computer 102 generates a plurality of paths 106, the computer 102 may determine whether objects are in the swept volumes 140 for all the paths 106. Upon determining that an object is in the swept volume 140 (or all the swept volumes 140), the process 900 proceeds to the block 920 to request a replacement waypoint 104. Upon determining that there is not an object in the swept volume 140 (or that there is not an object in at least one of the swept volumes 140), the process 900 proceeds to a block 940.

In the block 940, the computer 102 generates the velocity plan for the vehicle 100 to follow while traveling along the path 106, as described above. If the computer 102 generated a plurality of paths 106, the computer 102 may generate a velocity plan for each path 106 that did not have an object in its swept volume 140.

Next, in a block 945, the computer 102 selects one of the plurality of paths 106. The computer 102 can select the one of the paths 106 from the paths 106 that did not have objects in their swept volumes 140. The computer 102 can select the one of the paths 106 according to which path 106 has an optimal value for a criterion, e.g., a lowest value for maximum rate of steering angle change, a lowest quantity of steering angle change over the path 106, a lowest maximum value of jerk, a lowest time to travel from the starting point 108 to the waypoint 104, etc. If the computer 102 generated a single path 106, the computer 102 selects that path 106.

Next, in a block 950, the computer 102 transmits the message including the first parameters and second parameters to the remote receiver, as described above.

Next, in a block 955, the computer 102 instructs the propulsion 110, the steering system 112, and/or the brake system 116 of the vehicle 100 to actuate to navigate the vehicle 100 along the path 106 according to the velocity plan. The computer 102 can instruct the propulsion 110, the brake system 116, and the steering system 112 to actuate via the communications network 114. Alternatively, if the computer 102 is remote to the vehicle 100, the computer 102 can instruct the propulsion 110, the brake system 116, and the steering system 112 to actuate by transmitting a message including the first parameters and second parameters to the vehicle 100. At each point of the path 106 as defined by the value of the arclength s, the computer 102 can determine the steering angle γ for the steering system 112 based on the function defining the path 106, as described above. At each point of the path 106 as defined by the value of the arclength s, the computer 102 can determine the acceleration a for the propulsion 110 (or brake system 116 if the acceleration a is negative) based on the velocity plan, as described above. After the block 955, the process 900 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship. The adjectives “first,” “second,” and “third” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and a memory storing instructions executable by the processor to:
receive a waypoint;
generate a path for a vehicle from a starting point to the waypoint, the path characterized by a preset number of parameters; and
instruct a propulsion and a steering system of the vehicle to actuate to navigate the vehicle along the path.

2. The computer of claim 1, wherein the instructions further include instructions to, after generating the path, generate a velocity plan for the vehicle to follow while traveling along the path.

3. The computer of claim 2, wherein the path is represented as a piecewise function, and generating the velocity plan includes determining a piecewise constant acceleration for the path.

4. The computer of claim 3, wherein the parameters are first parameters, the velocity plan is characterized by a preset number of second parameters, and the second parameters define a plurality of constant accelerations forming the piecewise constant acceleration.

5. The computer of claim 3, wherein generating the velocity plan includes interpolating the piecewise constant acceleration with a constant jerk.

6. The computer of claim 2, wherein the parameters are first parameters, and the velocity plan is characterized by a preset number of second parameters.

7. The computer of claim 1, wherein the path is twice continuously differentiable.

8. The computer of claim 1, wherein the path includes at least one clothoid function.

9. The computer of claim 8, wherein the path includes three clothoid functions.

10. The computer of claim 9, wherein the three clothoid functions include a first clothoid function extending from the starting point to a first point, a second clothoid function extending from the first point to a second point, and a third clothoid function extending from a third point to the waypoint.

11. The computer of claim 10, wherein a curvature of the first clothoid function at the first point equals a curvature of the second clothoid function at the first point, and a curvature of the second clothoid function at the second point equals a curvature of the third clothoid function at the second point.

12. The computer of claim 10, wherein the parameters define path lengths for the clothoid functions.

13. The computer of claim 10, wherein the parameters define rates of change of curvature for the clothoid functions.

14. The computer of claim 1, wherein the parameters define the starting point and the waypoint.

15. The computer of claim 1, wherein the instructions further include instructions to transmit a message to a remote receiver, the message including the parameters.

16. The computer of claim 15, wherein
the parameters are first parameters;
the instructions further include instructions to, after generating the path, generate a velocity plan for the vehicle to follow while traveling along the path;
the velocity plan is characterized by a preset number of second parameters; and
the message includes the second parameters.

17. The computer of claim 1, wherein the instructions further include instructions to determine a feasibility of generating the path, and generating the path includes generating the path upon determining that generating the path is feasible.

18. The computer of claim 17, wherein the instructions further include instructions to request a replacement waypoint upon determining that generating the path is infeasible.

19. The computer of claim 1, wherein the instructions further include instructions to determine a swept volume of the vehicle based on the path, and, upon determining that an object is in the swept volume, request a replacement waypoint.

20. A method comprising:
receiving a waypoint;
generating a path for a vehicle from a starting point to the waypoint, the path characterized by a preset number of parameters; and
instructing a propulsion and a steering system of the vehicle to actuate to navigate the vehicle along the path.
